(19) United States
(12) Patent Application Publication
(10) Pub. No.: US 2005/0178226 A1
(43) Pub. Date: Aug. 18, 2005

(54) Gear transmitting device and electronic apparatus

(76) Inventors: Makoto Suzuki, Chiba-shi (JP); Kenji Suzuki, Chiba-shi (JP); Takayuki Satodate, Chiba-shi (JP); Haruhiko Hasegawa, Chiba-shi (JP)

Correspondence Address: BRUCE L. ADAMS, ESQ., 31ST FLOOR, 50 BROADWAY, NEW YORK, NY, 10004, US

(21) Appl. No.: 11/054,499

(22) Filed: Feb. 9, 2005

(30) Foreign Application Priority Data
Feb. 12, 2004 (JP) 2004-035557
Feb. 1, 2005 (JP) 2005-025556

(51) Int. Cl. F16H 1/06

(52) U.S. Cl. 74/414

(57) ABSTRACT

A gear transmitting device has such a structure as including an input gear, an output gear, and one or more intermediate gears for transmitting gear oscillation to the input and output gears. The gear transmitting device is also provided with a gear train including the input gear for transmitting oscillation to the output gear. The gear train includes, for gear engagement, one or more pairs of arc-circular tooth gears, and an involute tooth gear or a cycloidal tooth gear. With such a structure, the gear transmitting device can be reduced in size, and accordingly an electronic apparatus incorporating the gear transmitting device can be also reduced in size.

### BACKGROUND OF THE INVENTION

1. Field of the Invention

The present invention relates to a gear transmitting device for decelerating or accelerating the oscillation speed using a plurality of gears for transmission, and an electronic apparatus incorporating the gear transmitting device to drive a to-be-driven member using a gear driving device.

2. Description of the Related Art

For moving a date indicator provided to a watch with date indication, conventionally used is a gear transmitting device of a type including a string of arc-circular tooth gears. For details, refer to Patent Document 1 (JP-A-11-281772, paragraphs 0002 to 0003).

In the general industrial fields other than the field of watch, the popular type of a gear transmitting device is the one including a string of only involute tooth gears. Another popular type is a gear transmitting device including a string only of cycloidal tooth gears.

The issue here is that the gear transmitting device with a string of only arc-circular tooth gears as typically exemplified in Patent Document 1 will easily cause irregularities in the oscillation movement due to varying transmission angle. With the gear transmitting device including a string of only involute tooth gear, on the other hand, such irregularities in the oscillation movement can be corrected. This is because even if the center-to-center spacing between any two engaging gears varies to some extent, the angular speed remains the same, thereby maintaining proper gear engagement.

Because the arc-circular tooth gear cannot be engaged with the involute tooth gear, no such gear transmitting device including the gears of different kinds has been yet proposed.

Another concern is the module of the involute tooth gear used in the gear transmitting device, which is popular in the general industrial fields other than the field of watch. That is, its current module is of 0.1 mm at the minimum, and generally 1.5 mm to 6.0 mm. This module is considerably larger than that of the arc-circular tooth gear, and it means that the involute tooth gear is larger in diameter. Further, the gear ratio of a gear transmitting device including only the involute tooth gears is lower than another with only the arc-circular tooth gears.

Reducing the minimum number of gear teeth in the involute tooth gear of such a large module will lead to undercut limit, efficiency reduction, and others, at hobbing. In this viewpoint, the involute tooth gear is generally provided with at least 14 gear teeth, resultantly increasing the diameter. Moreover, the lower gear ratio is considered disadvantageous to increase the acceleration/deceleration ratio of the gear transmitting device. To derive any desired acceleration/deceleration ratio, it requires more involute tooth gears for use.

As a result, the gear transmitting device using only such involute tooth gears has been difficult to downsize, and the involute tooth gear has been an impediment to progress in downsizing an apparatus incorporating the gear transmitting device.

Such circumstances are similarly true to a gear transmitting device including a string of only cycloidal tooth gears.

In consideration of the above, an object of the invention is to provide small-sized gear transmitting device and electronic apparatus.

### SUMMARY OF THE INVENTION

In order to solve the above problems, an aspect of the invention is directed to a gear transmitting device including an input gear, an output gear, and one or more intermediate gears for transmitting gear oscillation to the input and output gears. The gear transmitting device is also provided with a gear train including the input gear for transmitting oscillation to the output gear. This gear train includes, for gear engagement, one or more pairs of arc-circular tooth gears and an involute tooth gear.

In this aspect and the following others, the input gear denotes a gear oscillating through engagement with a drive gear, which is driven by a power mechanism exemplified by a motor. The output gear denotes a gear engaging with a gear of a to-be-driven member that lastly receives the gear oscillation. Moreover, in this aspect and the following others, the intermediate gear denotes a pair of gears placed between the input and output gears for their oscillation, and engaging therewith. In this aspect and the following others, the arc-circular tooth gear denotes a gear whose teeth are all arc-shaped, i.e., the shape derived by approximating a cycloidal tooth with lines and circles. The involute tooth gear denotes a gear whose teeth are all involute, and the cycloidal tooth gear means a gear whose teeth are all cycloidal. Further, the gear transmitting device in this aspect and the following others can be put in use specifically for deceleration or acceleration. Still further, in this aspect and the following others, the gear train including the input gear for transmitting oscillation to the output gear may include a pair of engaging involute tooth gears, a pair of engaging cycloidal tooth gears, or both of these pairs.

In the gear transmitting device of this aspect, the gear train including the input gear for transmitting oscillation to the output gear is provided with a pair of arc-circular tooth gears, and an involute tooth gear. The arc-circular tooth gear is required to be accurate in shape, but the required level for the geometric accuracy is not that high. In this sense, the module of the arc-circular tooth gear can be reduced to a considerable extent compared with that of the involute tooth gear. This means that with the same number of teeth, the arc-circular tooth gear can be smaller in diameter than the involute tooth gear, successfully downsizing the gear train including a pair of arc-circular tooth gears. What is more, the gear ratio can be large for sure with the string of arc-circular tooth gears, favorably leading to any desired deceleration or acceleration ratio using the arc-circular tooth gear with less number of teeth. Accordingly, the gear train including a pair of arc-circular tooth gears can be successfully downsized.

Also, to solve the above-described problems, another aspect of the invention is directed to a gear transmitting device including an input gear, an output gear, and one or more intermediate gears for transmitting gear oscillation to the input and output gears. The gear transmitting device is also provided with a gear train including the input gear for transmitting oscillation to the output gear. The gear train includes, for gear engagement, one or more pairs of arc-circular tooth gears and a cycloidal tooth gear.

In the gear transmitting device of this aspect, the gear train including the input gear for transmitting oscillation to the output gear is provided with one or more pairs of arc-circular tooth gears, and a cycloidal tooth gear. The arc-circular tooth gear is required to be accurate in shape, but the required level for the geometric accuracy is not that high. In this sense, the module of the arc-circular tooth gear can be reduced to a considerable extent compared with that of the cycloidal tooth gear. This means that with the same number of teeth, the arc-circular tooth gear can be smaller in diameter than the cycloidal tooth gear, successfully downsizing the gear train including the pair(s) of arc-circular tooth gears. What is more, the gear ratio can be large for sure with the string of arc-circular tooth gears, favorably leading to any desired deceleration or acceleration ratio using the arc-circular tooth gear with less number of teeth. Accordingly, the gear train including the pair(s) of arc-circular tooth gears can be successfully downsized.

Further, to solve the above-described problems, still another aspect of the invention is directed to a gear transmitting device including an input gear, an output gear, and one or more intermediate gears for transmitting gear oscillation to the input and output gears. The gear transmitting device is also provided with a gear train including the input gear for transmitting oscillation to the output gear. The gear train partially includes a pair of engaging arc-circular tooth gears, and the remaining gear(s) and the output gear are all an involute tooth gear.

In the gear transmitting device of this aspect, the gear train including the input gear for transmitting oscillation to the output gear is provided with a pair of arc-circular tooth gears. As already described, the arc-circular tooth gear is required to be accurate in shape, but the required level for the geometric accuracy is not that high. In this sense, the module of the arc-circular tooth gear can be reduced to a considerable extent compared with that of the involute tooth gear. This means that with the same number of teethe the arc-circular tooth gear can be smaller in diameter than the involute tooth gear, successfully downsizing the gear train including a pair of arc-circular tooth gears. What is more, the gear ratio can be large for sure with the string of arc-circular tooth gears, favorably leading to any desired deceleration or acceleration ratio using the arc-circular tooth gear with less number of teeth. Accordingly, the gear train including a pair of arc-circular tooth gears can be favorably downsized.

Moreover, in this aspect, the output gear to be oscillated by the gear train is an involute tooth gear. Thus, the gear transmitting device of this aspect can be put in use by engaging the output gear with a to-be-driven gear, which is the involute tooth gear provided to the to-be-driven member. In the output stage, by such involute tooth gears engaging with each other, the irregularities in the oscillation movement can be corrected, which are resulted from the pair of arc-circular tooth gears in the gear train locating at least before the output gear.

Still further, to solve the above-described problems, still another aspect of the invention is directed to a gear transmitting device including an input gear, an output gear, and one or more intermediate gears for transmitting gear oscillation to the input and output gears. The gear transmitting device is also provided with a gear train including the input gear for transmitting oscillation to the output gear. The gear train includes one or more pairs of engaging arc-circular tooth gears, and the remaining gear(s) and the output gear are all a cycloidal tooth gear.

In the gear transmitting device of this aspect, the gear train including the input gear for transmitting oscillation to the output gear is provided with a pair of arc-circular tooth gears. As described above, the arc-circular tooth gear is required to be accurate in shape, but the required level for the geometric accuracy is not that high. In this sense, the module of the arc-circular tooth gear can be reduced to a considerable extent compared with that of the cycloidal tooth gear. This means that with the same number of teeth, the arc-circular tooth gear can be smaller in diameter than the cycloidal tooth gear, successfully downsizing the gear train including a pair of arc-circular tooth gears. What is more, the gear ratio can be large for sure with the string of arc-circular tooth gears, favorably leading to any desired deceleration or acceleration ratio using the arc-circular tooth gear with less number of teeth. Accordingly, the gear train including a pair of arc-circular tooth gears can be successfully downsized.

Moreover, in this aspect, the output gear to be oscillated by the gear train is a cycloidal tooth gear. Thus, the gear transmitting device of this aspect can be put in use by engaging the output gear with a to-be-driven gear, which is the cycloidal tooth gear provided to the to-be-driven member. In the output stage, by the cycloidal tooth gears engaging with each other, the irregularities in the oscillation movement can be corrected, which are resulted from the pair of arc-circular tooth gears in the gear train locating at least before the output gear.

Still further, to solve the above-described problems, still another aspect of the invention is directed to a gear transmitting device including an input gear, an output gear, and one or more intermediate gears for transmitting gear oscillation to the input and output gears. The gear transmitting device is also provided with a gear train including the input gear for transmitting oscillation to the output gear. The gear train includes one or more pairs of engaging arc-circular tooth gears, and the output gear is an involute tooth gear.

In the gear transmitting device of this aspect, the gear train including the input gear for transmitting oscillation to the output gear is provided with one or more pairs of arc-circular tooth gears. As already described above, the arc-circular tooth gear is required to be accurate in shape, but the required level for the geometric accuracy is not that high. In this sense, the module of the arc-circular tooth gear can be reduced to a considerable extent compared with that of the involute tooth gear. This means that with the same number of teeth, the arc-circular tooth gear can be smaller in diameter than the involute tooth gear, successfully downsizing the gear train including the pair(s) of arc-circular tooth gears. What is more, the gear ratio can be large for sure with the string of arc-circular tooth gears, favorably leading to any desired deceleration or acceleration ratio using the arc-circular tooth gear with less number of teeth. Accordingly, the gear train including the pair(s) of arc-circular tooth gears can be successfully downsized.

Moreover, in this aspect, the output gear to be oscillated by the gear train is an involute tooth gear. Thus, the gear transmitting device of this aspect can be put in use by engaging the output gear with a to-be-driven gear, which is the involute tooth gear provided to the to-be-driven member. In the output stage, by such involute tooth gears engaging with each other, the irregularities in the oscillation movement can be corrected, which are resulted from the pair(s) of arc-circular tooth gears in the gear train locating at least before the output gear.

Still further, still another aspect of the invention is directed to a gear transmitting device including an input gear, an output gear, and one or more intermediate gears for transmitting gear oscillation to the input and output gears. The gear transmitting device is also provided with a gear train including the input gear for transmitting oscillation to the output gear. The gear train includes one or more pairs of engaging arc-circular tooth gear, and the output gear is a cycloidal tooth gear.

In the gear transmitting device of this aspect, the gear train including the input gear for transmitting oscillation to the output gear is provided with one or more pairs of arc-circular tooth gears. As described in the foregoing, the arc-circular tooth gear is required to be accurate in shape, but the required level for the geometric accuracy is not that high. In this sense, the module of the arc-circular tooth gear can be reduced to a considerable extent compared with that of the cycloidal tooth gear. This means that with the same number of teeth, the arc-circular tooth gear can be smaller in diameter than the cycloidal tooth gear, successfully downsizing the gear train including the pair(s) of arc-circular tooth gears. What is more, the gear ratio can be large for sure with the string of arc-circular tooth gears, favorably leading to any desired deceleration or acceleration ratio using the arc-circular tooth gear with less number of teeth. Accordingly, the gear train including the pair(s) of arc-circular tooth gears can be successfully downsized.

Moreover, in this aspect, the output gear to be oscillated by the gear train is a cycloidal tooth gear. Thus, the gear transmitting device of this aspect can be put in use by engaging the output gear with a to-be-driven gear, which is the cycloidal tooth gear provided to the to-be-driven member. In the output stage, by the cycloidal tooth gears engaging with each other, the irregularities in the oscillation movement can be corrected, which are resulted from the pair of arc-circular tooth gears in the gear train locating at least before the output gear.

As a preferable embodiment of the gear transmitting device of the invention, all gears except the output gear may be an arc-circular tooth gear. With this being the case, the gear train including the input gear for transmitting oscillation to the output gear can be reduced in size to a greater degree.

As another preferable embodiment of the gear transmitting device of the invention, the involute tooth gear or the cycloidal tooth gear may be placed on the same axis as one of the paired arc-circular tooth gears for oscillation together. If this is the case, the pair of arc-circular tooth gears can be combined together with the involute tooth gear or the cycloidal tooth gear, thereby favorably rendering the gear transmitting device downsized.

As still another preferable embodiment of the gear transmitting device of the invention, the gear at the tail of the gear train may be an arc-circular tooth gear, and the output gear and the tail gear may be coaxially placed as a piece for oscillation together. With such a structure, the output gear and the tail gear in the gear train including the input gear for transmitting oscillation to the output gear can be formed all in a piece, thereby favorably leading to the lower cost.

As still another preferable embodiment of the gear transmitting device of the invention, the gear at the tail of the gear train may be an arc-circular tooth gear, and the output gear and the tail gear may be formed separately but placed coaxially to oscillate together. With this being the case, the output gear may be of any arbitrary module for use with the tail gear in the gear train including the input gear for transmitting oscillation to the output gear. Accordingly, the resulting gear train becomes applicable to an involute or cycloidal tooth gear whichever provided to the type-varying to-be-driven member, which is engaged with the output gear.

As still another preferable embodiment of the gear transmitting device of the invention, the gear at the tail of the gear train may be an arc-circular tooth gear, and the output gear and the tail gear oscillating together are formed in a piece with an axis provided for gear support. Such a structure allows integral formation of the output gear, the tail gear in the gear train including the input gear for transmitting oscillation to the output gear, and the axis provided for gear support, thereby favorably reducing the cost.

Moreover, to solve the above-described problems, still another aspect of the invention is directed to an electronic apparatus provided with a to-be-driven member including a to-be-driven gear, and any one of the gear transmitting devices described above for driving the to-be-driven member. As such, the electronic apparatus of this aspect includes any one of the above-described gear transmitting devices, and thus downsizing the gear transmitting device will lead to downsizing of the electronic apparatus.

As such, according to the invention, provided is a small-sized gear transmitting device because of such a structure that a gear train including an input gear for transmitting oscillation to an output gear is provided with a pair of arc-circular tooth gears and an involute or cycloidal tooth gear.

Further, according to the invention, provided is a small-sized gear transmitting device because a gear train including an input gear for transmitting oscillation to an output gear includes a pair of arc-circular tooth gears.

Still further, provided is a small-sized gear transmitting device because a gear train including an input gear for transmitting oscillation to an output gear at least includes a pair of arc-circular tooth gears.

Still further, according to the invention, provided is a smaller-sized gear transmitting device because all gears except an output gear are an arc-circular tooth gear.

Still further, according to the invention, provided is a gear transmitting device capable of cost reduction with such a structure that the tail gear in the gear train and the output gear are formed in a piece for coaxial placement.

Still further, according to the invention, provided is a gear transmitting device of a structure in which a tail gear in a gear train and an output gear are separately formed for coaxial placement. With such a structure, the gear train including an input gear for transmitting oscillation to the output gear becomes applicable to an involute or cycloidal tooth to-be-driven gear whichever provided to a type-varying to-be-driven member, which is engaged with the output gear.

Still further, according to the invention, provided is a gear transmitting device capable of cost reduction with the integral formation of a gear at the tail in a gear train, an output gear to be coaxially placed with the tail gear, and an axis provided for gear support.

Still further, according to the invention, provided is a small-sized electronic apparatus incorporating a gear transmitting device that is reduced in size due to a gear train including an input gear for transmitting oscillation to an output gear is provided with a pair of arc-circular tooth gears.

### BRIEF DESCRIPTION OF THE DRAWINGS

FIG. 1 is a cross section view of a gear transmitting device of a first embodiment of the invention;

FIG. 2 is a plan view of a gear train in the gear transmitting device of FIG. 1;

FIG. 3 is a plan view of a drive gear for the gear transmitting device of FIG. 1;

FIG. 4A is a plan view of a gear unit provided to the gear transmitting device of FIG. 1;

FIG. 4B is a cross section view of the gear unit of FIG. 4A;

FIG. 4C is a bottom view of the gear unit of FIG. 4A;

FIG. 5A is a plan view of a gear unit provided in the last stage of the gear transmitting device of FIG. 1;

FIG. 5B is a cross section view of the gear unit of FIG. 5A;

FIG. 5C is a bottom view of the gear unit of FIG. 5A;

FIG. 6 is a plan view of a to-be-driven gear that receives oscillation from the gear transmitting device of FIG. 1;

FIG. 7 is a cross section view of a gear unit in the last stage of a gear transmitting device of a second embodiment of the invention;

FIG. 8 is a cross section view of a gear unit in the last stage of a gear transmitting device of a third embodiment of the invention;

FIG. 9 is a cross section view showing the structure of a camera module of a fourth embodiment of the invention; and

FIG. 10 is a block diagram showing the structure of an electronic camera with the camera module of FIG. 9.

### DETAILED DESCRIPTION OF THE PREFERRED EMBODIMENTS

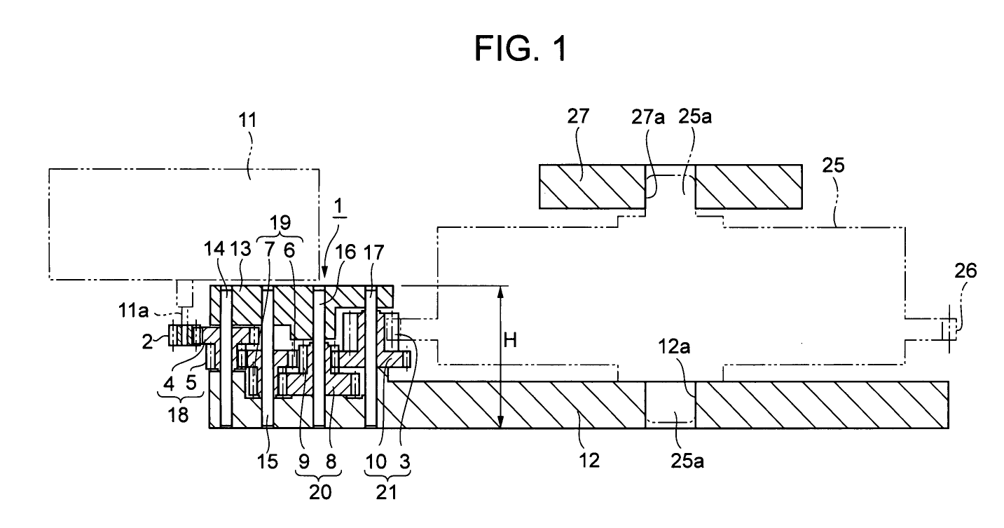

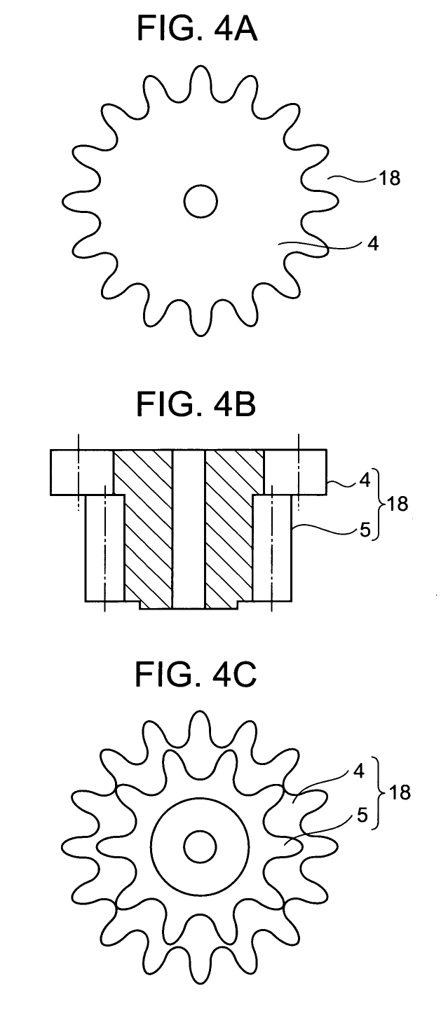

By referring to FIGS. 1 to 6, a first embodiment of the invention is described.

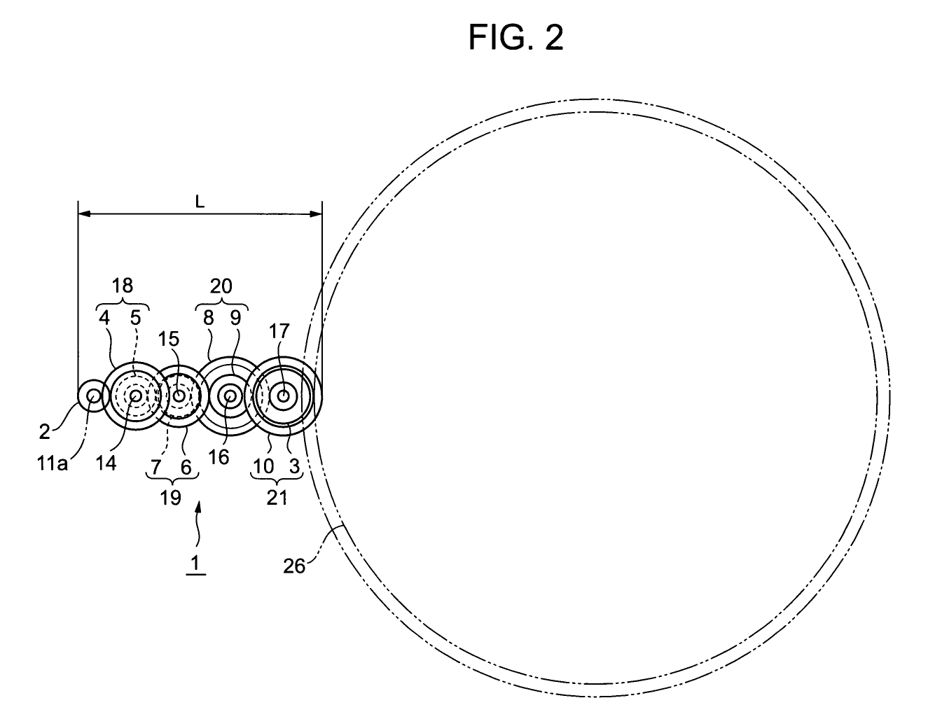

A gear transmitting device denoted by a reference numeral 1 in FIGS. 1 and 2 is provided with an output gear 3, an input gear 4, and first to sixth intermediate gears 5 to 10 for transmitting oscillation movement to both the input and output gears 4 and 3 by three-stage deceleration.

As shown in FIG. 1, the input gear 4 is engaged with a drive gear 2, which is attached to a drive section, e.g., an oscillation axis 11a of a motor 11. The motor 11 is exemplified by various types of motors, including electrical motors such as ultrasonic motor and step motor, air motors, hydraulic motors, or others.

As shown in FIG. 2, the output gear 3 and the intermediate gears 5 to 10 are placed between first and second support members 12 and 13, both of which have the shape of a plate, for example. That is, across the first and second support members 12 and 13 facing each other, first to fourth axes 14 to 17 are fixed in parallel. The first axis 14 is supporting the input gear 4 and the first intermediate gear 5 to freely oscillate. Because being on the same axis, the input gear 4 and the first intermediate gear 5 oscillate together. The input gear 4 and the first intermediate gear 5 are of a piece, serving as a first gear unit 18. The input gear 4 is larger in diameter than the drive gear 2 and the first intermediate gear 5, and is engaged with the drive gear 2.

The second axis 15 is supporting the second and third intermediate gears 6 and 7 to freely oscillate. Because being on the same axis, the second and third intermediate gears 6 and 7 oscillate together. These second and third intermediate gears 6 and 7 are of a piece, serving as a second gear unit 19. The second intermediate gear 6 is larger in diameter than the first and third intermediate gears 5 and 7, and is engaged with the first intermediate gear 5.

The third axis 16 is supporting the fourth and fifth intermediate gears 8 and 9 to freely oscillate. Because being on the same axis, the fourth and fifth intermediate gears 8 and 9 oscillate together. These fourth and fifth intermediate gears 8 and 9 are of a piece, serving as a third gear unit 20. The fourth intermediate gear 8 is larger in diameter than the third and fifth intermediate gears 7 and 9, and is engaged with the third intermediate gear 7.

The fourth axis 17 is supporting the sixth intermediate gear 10 and the output gear 3 to freely oscillate. Because being on the same axis, the sixth intermediate gear 10 and the output gear 3 oscillate together. The sixth intermediate gear 10 and the output gear 3 are of a piece, serving as a fourth gear unit 21. The sixth intermediate gear 10 is larger in diameter than the fifth intermediate gear 9 and the output gear 3, and is engaged with the fifth intermediate gear 9.

In FIG. 1, the first and second gear units 18 and 19 are placed opposite in direction to the third and fourth gear units 20 and 21. With such a placement, compared with a case where these gear units 18 to 21 are all placed in the same direction, the gear transmitting device 1 can be controlled in thickness, which is denoted by a dimension H in FIG. 1. The gear units 18 to 21 are made of hard synthetic resin or light metal, and formed in a piece. Forming the gear units 18 to 21 in a piece as such favorably eliminates the need to form gears varying size, i.e., large and small, and to couple thus formed gears, thereby preferably leading to cost reduction. Herein, the large gears include the input gear 4, and the intermediate gears 6, 8, and 10, and the small gears include the intermediate gears 5, 7, and 9, and the output gear 3.

The input gear 4 and the first to sixth intermediate gears 5 to 10 are forming a gear train, serving to transmit oscillation of the drive gear to the output gear 3. Here, the drive gear 2 is oscillated by the motor 11, and the oscillation is decelerated before transmitted. This gear train includes first to third gear pairs. The first gear pair includes the first intermediate gear 5 oscillating together with the input gear 4, and the second intermediate gear 6 engaging with the first intermediate gear 5. The second gear pair includes the third intermediate gear 7 oscillating together with the second intermediate gear 6, and the fourth intermediate gear 8 engaging with the third intermediate gear 7. The third gear pair includes the fifth intermediate gear 9 oscillating together with the fourth intermediate gear 8, and the sixth intermediate gear 10 engaging with the fifth intermediate gear 9. The drive gear 2 is also paired with the engaging input gear 4, and this pair may be also included in the gear train.

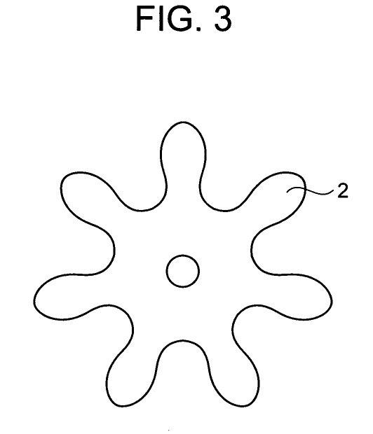

As typically shown in FIGS. 3, 4A to 4C, 5C, and others, the gears 4 to 10 forming a gear train, and the drive gear 2 working to drive the gear train are all an arc-circular tooth gear. The teeth of the arc-circular tooth gear have the shape derived by approximating a cycloidal tooth with lines and circles. Compared with the popularly-used involute teeth gear, the arc-circular tooth gear has the following characteristics. First of all, its module is very small about 0.06 mm to 0.2 mm, and in connection therewith, the minimum number of teeth is 6 with the current technology. This accordingly increases the gear ratio (deceleration ratio or acceleration ratio) for a gear pair to be 10:1 at the maximum. Secondly, the arc-circular tooth gear is suitable for the low oscillation speed, serving well for transmission of oscillation movement and torque. Thirdly, with the structure of a circle and linear lines, the standard of the arc-circular tooth gear is easily derived for teeth testing.

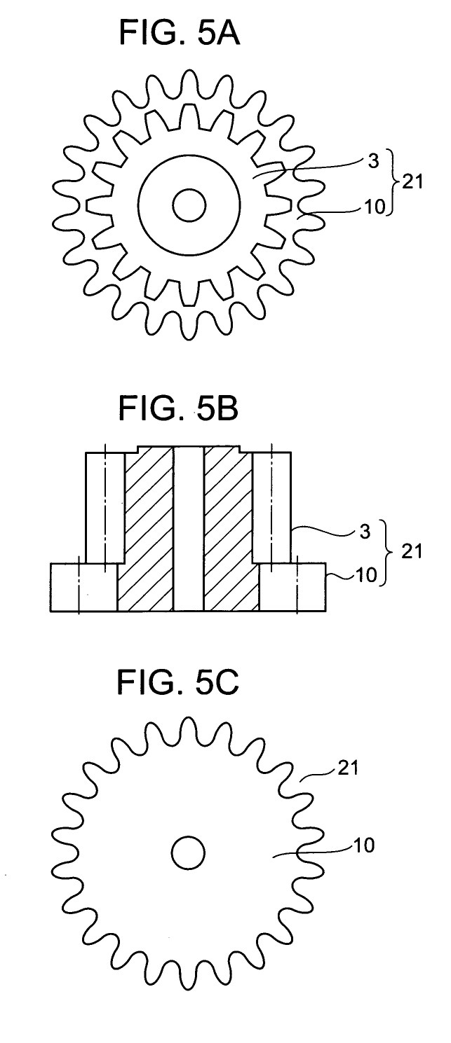

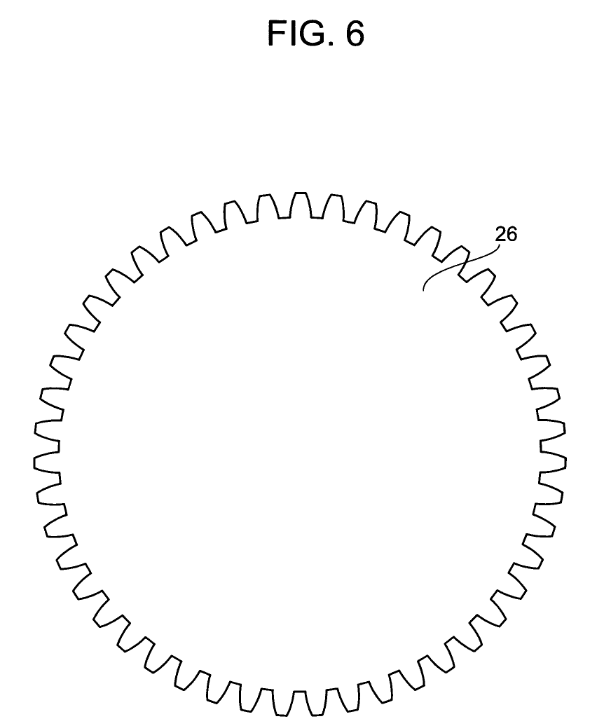

As shown in FIG. 5A, the output gear 3 receiving the oscillation movement from the gear train is an involute tooth gear. As shown in FIGS. 1 and 2, the output gear 3 is engaged with a to-be-driven gear 26 provided to a to-be-driven member 25. The to-be-driven gear 26 is also an involute tooth gear as shown in FIG. 6. As shown in FIG. 1, the to-be-driven member 25 has a pair of axis portions 25a, which are respectively fit in, to freely oscillate, a bearing hole 12a of the first support member 12, and another bearing hole 27a of a third support member 27. Here, the third support member 27 is the one placed corresponding to the first support member 12.

The gear transmitting device 1 reduces the oscillation speed of the motor 11 for transmission to the output gear 3. At this time, the oscillation speed of the oscillation axis 11a of the motor 11 is reduced in the following order, i.e., first by the pair of gears 2 and 4 on the input side, by the first pair of gears 5 and 6, by the second pair of gears 7 and 8, and then the third pair of gears 9 and 10 on the output side. With thus reduced speed, the output gear 3 oscillates together with the sixth intermediate gear (last gear) 10, and the to-be-driven member 25 accordingly oscillates through engagement between the output gear 3 and the to-be-driven gear 26.

In the gear transmitting device 1 operating as such, the gear pairs of a string including the input gear 4 are all an arc-circular tooth gear for transmitting oscillation to the output gear 3. As already described, the module of an arc-circular tooth gear is considerably smaller than that of an involute tooth gear, and thus with the same number of teeth, the arc-circular tooth gear can be smaller in diameter than the involute tooth gear, successfully downsizing the gear train including a pair (s) of arc-circular tooth gears. What is more, as already described above, the gear ratio can be large for sure with the string of arc-circular tooth gears, favorably leading to any desired deceleration ratio using the arc circular tooth gear with less number of teeth. Accordingly, the gear train including a pair(s) of arc-circular tooth gears can be favorably downsized. What is more, such an arc-circular tooth gear having the larger gear ratio serves well in the structure of the first embodiment, i.e., the gears except the output gear 3 are all an arc-circular tooth gear. That is, the deceleration ratio can be large for the first to third gear pairs, and the gear pair including the input gear in the preceding stage, thereby successfully downsizing the gear train transmitting oscillation to the output gear 3. This accordingly reduces the number of gears needed to derive any predetermined deceleration ratio, and the space needed for the gear transmitting device 1 of the first embodiment. As a result, any small-sized apparatus incorporating the gear transmitting device can be downsized to a further extent.

Described now is the comparative example between gear transmitting devices 1 of the same structure but different teeth type and module. Specifically, the oscillation axis 11a of the motor 11, and the first to fourth axes 14 to 17 are all linearly arranged as shown in FIG. 2. The gear transmitting devices each have the same number of gears, and every gear has the same number of teeth, i.e., the same deceleration ratio. One of the gear transmitting devices carries arc-circular tooth gears each having the minimum module of 0.06 mm, and the resulting length becomes L. The other gear transmitting device carries involute tooth gears each having the minimum module of 0.1 mm, and the resulting length becomes 1.67L. That is, the former device, i.e., the gear transmitting device 1 in the first embodiment, is favorably reduced in size compared with the latter device. If these two devices have the same deceleration ratio, the teeth may be reduced in number for use, and with this being the case, the gear transmitting device 1 can be downsized to a further extent.

Further, in the gear transmitting device 1, the output gear 3 in the output stage is an involute tooth gear. This allows the output gear 3 to engage with the to-be-driven gear 26 being also an involute tooth gear provided to the to-be-driven member 25 to operate the gear transmitting device 1. In more detail, carrying the involute-type output gear 3 means that the gear transmitting device 1 can work with the popularly-used involute tooth gear no matter if the device is including the arc-circular tooth gear, thereby achieving versatility.

In the output stage, the gear engagement between the involute tooth gears transmits oscillation. Even if the center-to-center spacing between any two involute tooth gears varies to some extent, the angular speed remains the same so that the gear engagement is properly maintained for oscillation transmission. Therefore, the gear engagement in the output stage can control any irregularities in the oscillation movement that are often resulted from the pair(s) of arc-circular tooth gears locating before the output gear 3.

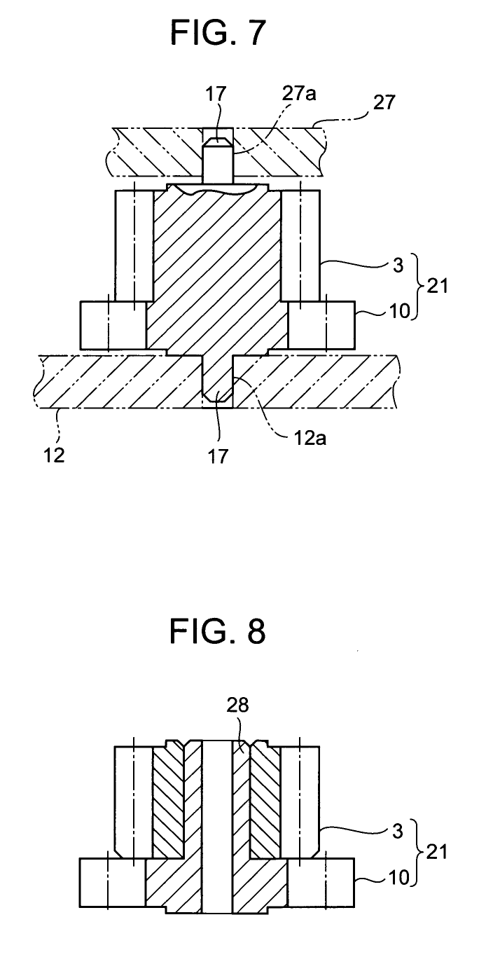

FIG. 7 is a diagram showing a second embodiment of the invention. The second embodiment is basically the same as the first embodiment, and thus any components same as those in the first embodiment are under the same reference numerals, and not described again. Described below are only components different from those in the first embodiment.

In the second embodiment, the fourth gear unit 21 includes the output gear (small gear) 3, the sixth intermediate gear (large gear) 10, and the fourth axis 17, all of which are formed in a piece. The output gear 3 oscillates with the sixth intermediate gear 10, and the fourth axis 17 protrudes from the output gear 3 and the sixth intermediate gear 10 for their support. Such a fourth gear unit 21 is attached, to freely oscillate, to the bearing hole 12a of the first support member 12 and the bearing hole 27a of the third support member 27 by inserting the fourth axis 17 thereinto, respectively. Alternatively, for attachment of the fourth gear unit 21 to freely oscillate, the bearing holes 12a and 27a may be each attached with a bearing to support the fourth axis 17 supporting the output gear 3 and the sixth intermediate gear 10. Such a structure of the fourth gear unit 21, i.e., the large and small gears are coaxially formed in a piece, is applied to the first to third gear units not shown in FIG. 7.

The remaining components including those not shown in FIG. 7 are the same as those in the first embodiment, and thus the object of the invention can be achieved also by the second embodiment. As typically exemplified by the fourth gear unit 21, the fourth axis 17 that can freely oscillate is formed in a piece with the large gear, i.e., the sixth intermediate gear 10, and the small gear, i.e., the output gear 3. This thus eliminates the need to individually form these components, and assemble a gear unit from the resulting components, thereby preferably leading to cost reduction.

FIG. 8 is a diagram showing a third embodiment of the invention. The third embodiment is basically the same as the first embodiment, and thus any components same as those in the first embodiment are under the same reference numerals, and not described again. Described below are only components different from those in the first embodiment.

In the third embodiment, in the fourth gear unit 21, the output gear (small gear) 3 is separately provided, for oscillation together, from the sixth intermediate gear (large gear) 10. These two components are assembled together so that the fourth gear unit 21 is derived. For the assembly purpose, the sixth intermediate gear 10 has a tube portion 28 protruding from the center part of one plane to the other for support by the fourth axis (not shown in FIG. 8, and refer to the reference numeral 17 in FIGS. 1 and 2) to freely oscillate. Around the tube portion 28, the output gear 3 is attached with a good fit. The structure of this fourth gear unit 21 is applied to the first to third gear units, which are not shown in FIG. 8.

As an alternative structure to the above, the tube portion 28 to be supported by the fourth axis (not shown in FIG. 8, and refer to the reference numeral 17 in FIGS. 1 and 2) to freely oscillate may be made to protrude from the center part of a plane of the output gear 3, and around the tube portion 28, the sixth intermediate (large gear) gear 10 is attached with a good fit separately from the output gear 3. In either structure, the tube portion 28 may be replaced by an axis portion, and the portion locating at the center from both ends of this axis portion, the fourth axis 17 may be protruded to be a piece therewith. With this being the case, the fourth gear unit 21 is attached, to freely oscillate, to the bearing holes 12a and 27a of the first and third support members 12 and 27 directly or indirectly via bearings.

The remaining components including those not shown in FIG. 8 are the same as those in the first embodiment, and thus the object of the invention can be achieved also by the third embodiment. What is more, as typically exemplified by the fourth gear unit 21, the output gear 3 is separately provided from the sixth intermediate gear 10 locating at the tail of the gear train used for oscillation transmission, and the output gear 3 and the sixth intermediate gear 10 are placed coaxially. This structure is considered preferable in the respect that the gear train becomes applicable to the involute to-be-driven gear 26 (refer to FIG. 2) of the type-varying to-be-driven member 25 (refer to FIG. 2), which is engaged with the output gear 3.

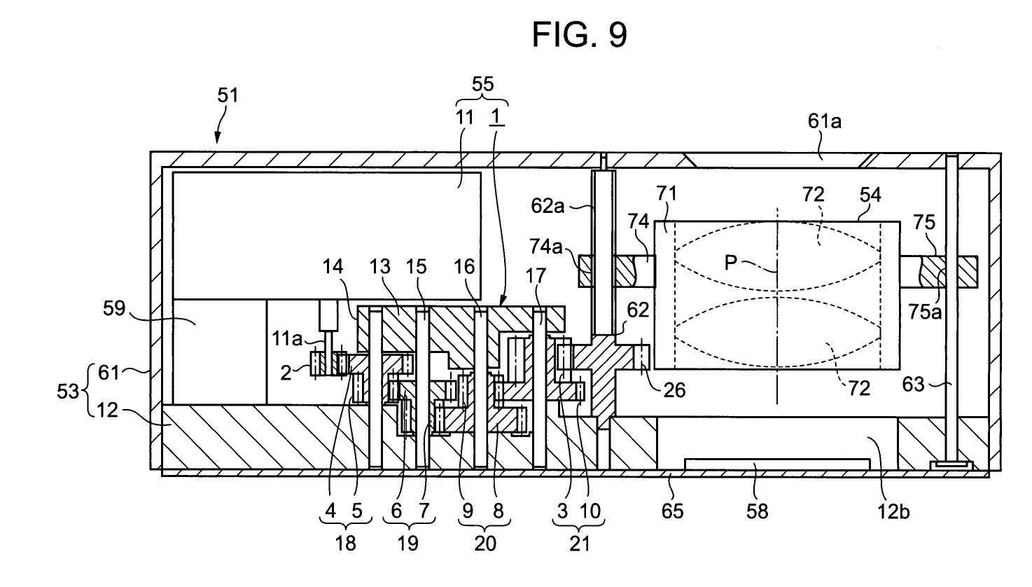

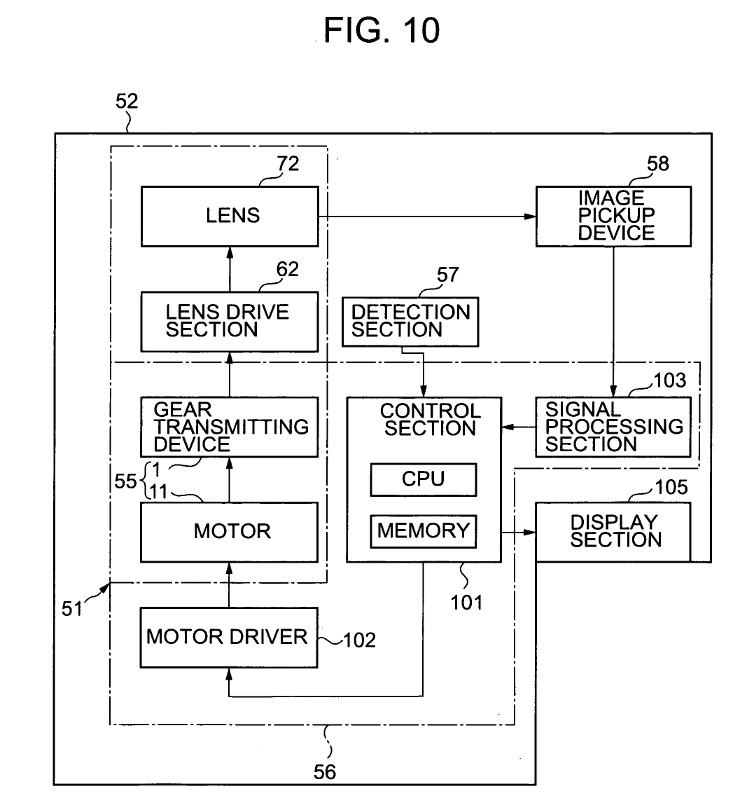

FIGS. 9 and 10 both are a diagram showing a fourth embodiment of the invention. The fourth embodiment is basically the same as the first embodiment, and thus any components same as those in the first embodiment are under the same reference numerals, and not described again. Described below are only components different from those in the first embodiment.

In FIGS. 9 and 10, a reference numeral 51 denotes a camera module. The camera module 51 is incorporated on a printed circuit in the body (not shown) of an electronic apparatus 52 (refer to FIG. 10). The electronic apparatus 52 is exemplified by portable electronic apparatus including card-shaped digital camera, camera-provided cellular phone, or others. The camera module 51 has a casing 53 carrying therein a mirror tube 54, a drive unit 55, a circuit block 56, a detection section 57, an image pickup device 58, and others.

The casing 53 is formed by coupling a cover 61 to the first support member 12 of the gear transmitting device 1. The first support member 12 serving as a base has an aperture 12b. The cover 61 is covering a surface of the first support member 12, and has a light gathering hole 61a. The aperture 12b and the light gathering hole 61a are provided in the thickness direction of the casing 53.

The casing 53 is provided with a to-be-driven axis 62, and at least a guide axis 63. The to-be-driven axis 62 is located around the light gathering hole 61a to serve as a to-be-driven member, e.g., lens drive section. The to-be-driven axis 62 is inserted and supported, at both ends, by the first support member 12 and the cover 61 to freely oscillate. The guide axis 63 is inserted and securely fixed, at both ends, to the first support member 12 and the cover 61 to freely oscillate. The to-be-driven 62 is parallel to the guide axis 63.

The to-be-driven axis 62 includes, as a coaxial piece, the to-be-driven gear 26. This to-be-driven gear 26 is a cycloidal tooth gear. The axis portion on the side of the cover 61 from the to-be-driven gear 26 of the to-be-driven axis 62 is formed to a feed screw portion 62a.

The back surface of the first support member 12 is attached with a circuit board 65. At the part where the aperture 12b of the circuit board 65 is closed, the image pickup device 58 is incorporated. The image pickup device 58 is exemplified by a semiconductor device such as CCD or CMOS. On the circuit board 65, incorporated are a control section 101, a motor driver 102, and a signal processing section 103, and others, shown in FIG. 10.

As shown in FIG. 9, the mirror tube 54 carries a lens holder 71 including a plurality of lenses 72 in its cylindrical portion. From around the cylindrical portion of the lens holder 71, a plurality of, e.g., a pair of convex portions 74 and 75 are protruding. The convex portion 74 is formed with a screw hole 74a to go through in the thickness direction, and the other convex portion 75 is formed with a hole 75a to go through in the thickness direction.

To the screw hole 74a, the feed screw portion 62a is screwed so that the to-be-driven axis 62 is gone through. To the hole 75a, the guide axis 63 is inserted. The convex portion 75 can slide in contact along the axial direction of the guide axis 63. Accordingly, the mirror tube 54 is placed inside of the casing 53 between the image pickup device 58 and the light gathering hole 61a while being supported across the to-be-driven axis 62 and the guide axis 63. This mirror tube 54 moves along the direction into which the axis line of the to-be-driven axis 62 and the guide axis 63 extends, i.e., the direction into which an optical axis P of the mirror tube 54 extends. The mirror tube 54 moves as the feed screw portion 62a and the screw hole 74a are engaged together responsively when the to-be-driven axis 62 oscillates. By the mirror tube 54 moving as such, the lens 72 on the optical axis P is changed in position to focus on the image pickup device 58.

In the present embodiment, the driving device 55 is provided to drive the mirror tube 54 via the to-be-driven axis 62, and includes the electronic motor 11 serving as a drive section inside of the casing 53, and the gear transmitting device 1 coupled thereto, for example. The driving device 55 and the to-be-driven axis 62 serve as a lens driving device.

The motor 11 functioning as an actuator is preferably a stepping motor. This motor 11 is coupled onto a motor support member 59, which is fixed to the first support member 12. The gear transmitting device 1 has the same structure as that in the first embodiment. In the gear transmitting device 1, the output device 3 locating at the tail is a cycloidal tooth gear, and is engaged with the to-be-driven gear 26 of the to-be-driven axis 62.

As shown in FIG. 10, the circuit block 56 is provided with the control section 101, the motor driver 102, the signal processing section 103, and others. The control section 101 includes a CPU, memory, and the like, and exercises control over the camera module 51, e.g., controls the operation of the image pickup device 58. At the time of driving the motor 11 of the driving device 55, the motor driver 102 applies the number of drive pulses needed for the motor 11. The signal processing section 103 processes a video signal coming from the image pickup device 58 for supply to the control section 101. When the mirror tube 54 is moved for control, the detection section 57 of FIG. 10 detects, for example optically, the position from which the mirror tube 54 is moved, i.e., the point of origin. In FIG. 10, a reference numeral 105 denotes a display section exposing outside of the electronic apparatus 52. The display section 105 is an LCD or others, and displays various information stored in the memory, including information about images picked up by the image pickup device 58.

The electronic apparatus 52 of the fourth embodiment functions as an electronic camera, and its camera module 51 is including the gear transmitting device 1 of the first embodiment. Accordingly, the object of the invention can be achieved also in this fourth embodiment, and downsizing the gear transmitting device 1 favorably leads to downsizing of the camera module 51. By extension, as the space needed for the camera module 51 is reduced in the body of the electronic apparatus 52, the electronic apparatus 52 is accordingly downsized, and if downsizing is not an option, the packing density of the components can be improved in the apparatus body.

Note that, in the fourth embodiment, the lens 72 is used for auto focus. Alternatively, in addition to such a focus lens a second mirror tube including a zoom lens may be so provided as to be supported, similarly to the above, across the guide axis 63 and a to-be-driven axis for zooming, which is separately provided from the to-be-driven axis 62. In this alternative structure, for zooming operation, a zoom driving device including the gear transmitting device 1 may move the second mirror tube responsively to the oscillation of the zooming to-be-driven axis in the direction along which an optical axis extends. Still alternatively, using an iris driving device including the gear transmitting device 1 is an option for diaphragm control by driving an iris, or using other types of driving device including the gear transmitting device 1 to control other types of optical components is also an option.

Other than the electronic camera described in the fourth embodiment, the invention is applicable to various types of electronic apparatuses including, as a to-be-driven member, electronic clocks with hands (e.g., table clocks, wall clocks, and portable clocks), electronic measurement equipment with a measurement needle, printers and printing presses with a paper feeding mechanism powered by a stepping motor, machine tools with a rotating cutter tool, robots with joints, movement devices such as X-Y stage, storage devices for driving disks such as magnetic disks and optical disks, and the like.

The output gear 3 of the fourth embodiment may be an involute tooth gear.

The invention is not restrictive to the above-described embodiments. For example, the gear train not including the drive gear 2 but including at least the input gear 4 for oscillation transmission to the output gear 3 is described as including a plurality of gear pairs. Alternatively, at least one of the gear pairs may be so set as to be arc-circular tooth gears. With this being the case, the input gear 4 and its engaging drive gear 2 may be so set as to be involute or cycloidal tooth gears. Especially, the drive gear of the commercially-available drive mechanism for use as the drive section often includes involute tooth gears. Thus, using an involute tooth gear for the input gear 4 is considered preferable in the respect that the commercially-available drive mechanism (drive section) becomes applicable thereto.

Moreover, the number of gear pairs of arc-circular tooth gears may be set in accordance with the deceleration ratio (or acceleration ratio) and the space available for the small-sized apparatus. The gear train not including the drive gear 2 but including at least the input gear 4 for oscillation transmission to the output gear 3 may have at least a gear pair. If this is the case, this gear pair may be the drive gear 2 and the input gear 4, both of which are arc-circular tooth gears.

In the invention, in the gear train in the gear transmitting device, every intermediate gear other than the gear pair(s) of arc-circular tooth gears may be of any arbitrary combinations suiting to drive the to-be-driven gear, derived through selection of two or more kinds from the arc-circular tooth gear, the involute tooth gear, and the cycloidal tooth gear.

1. A gear transmitting device including an input gear, an output gear, and one or more intermediate gears for transmitting gear oscillation to the input gear and the output gear, comprising:
a gear train including the input gear for transmitting oscillation to the output gear, wherein
the gear train includes, for gear engagement, one or more pairs of arc-circular tooth gears and an involute tooth gear.

2. A gear transmitting device including an input gear, an output gear, and one or more intermediate gears for transmitting gear oscillation to the input gear and the output gear, comprising:
a gear train including the input gear for transmitting oscillation to the output gear, wherein
the gear train includes, for gear engagement, one or more pairs of arc-circular tooth gears and a cycloidal tooth gear.

3. A gear transmitting device including an input gear, an output gear, and one or more intermediate gears for transmitting gear oscillation to the input gear and the output gear, comprising:
a gear train including the input gear for transmitting oscillation to the output gear, wherein
the gear train includes a pair of engaging arc-circular tooth gears, and the remaining gear(s) and the output gear are each an involute tooth gear.

4. A gear transmitting device including an input gear, an output gear, and one or more intermediate gears for transmitting gear oscillation to the input gear and the output gear, comprising:
a gear train including the input gear for transmitting oscillation to the output gear, wherein
the gear train includes one or more pairs of engaging arc-circular tooth gears, and the remaining gear(s) and the output gear are each a cycloidal tooth gear.

5. A gear transmitting device including an input gear, an output gear, and one or more intermediate gears for transmitting gear oscillation to the input gear and the output gear, comprising:
a gear train including the input gear for transmitting oscillation to the output gear, wherein
the gear train includes one or more pairs of engaging arc-circular tooth gears, and the output gear is an involute tooth gear.

6. A gear transmitting device including an input gear, an output gear, and one or more intermediate gears for transmitting gear oscillation to the input gear and the output gear, comprising:
a gear train including the input gear for transmitting oscillation to the output gear, wherein
the gear train includes one or more pairs of engaging arc-circular tooth gears, and the output gear is a cycloidal tooth gear.

7. The gear transmitting device according to claim 1, wherein
the gears other than the output gear are the arc-circular tooth gear.

8. The gear transmitting device according to claim 2, wherein
the gears other than the output gear are the arc-circular tooth gear.

9. The gear transmitting device according to claim 1, wherein
the involute tooth gear or the cycloidal tooth gear may be placed on the same axis as one of the paired arc-circular tooth gears for oscillation together.

10. The gear transmitting device according to claim 2, wherein
the involute tooth gear or the cycloidal tooth gear may be placed on the same axis as one of the paired arc-circular tooth gears for oscillation together.

11. The gear transmitting device according to claim 9, wherein
the gear at an tail of the gear train is the arc-circular tooth gear, and the output gear and the tail gear are placed on the same axis as a piece for oscillation together.

12. The gear transmitting device according to claim 10, wherein
the gear at an tail of the gear train is the arc-circular tooth gear, and the output gear and the tail gear are placed on the same axis as a piece for oscillation together.

13. The gear transmitting device according to claim 9, wherein
the gear at an tail of the gear train is the arc-circular tooth gear, and the output gear and the tail gear are formed individually, and placed on the same axis for oscillation together.

14. The gear transmitting device according to claim 10, wherein
the gear at an tail of the gear train is the arc-circular tooth gear, and the output gear and the tail gear are formed individually, and placed on the same axis for oscillation together.

15. The gear transmitting device according to claim 1, wherein
the gear at an tail of the gear train is the arc-circular tooth gear, and the output gear and the tail gear oscillating together are in a piece with an axis for gear support.

16. The gear transmitting device according to claim 2, wherein
the gear at an tail of the gear train is the arc-circular tooth gear, and the output gear and the tail gear oscillating together are in a piece with an axis for gear support.

17. An electronic apparatus, comprising:
a to-be-driven member including a to-be-driven gear; and
the gear transmitting device of claim 1 for driving the to-be-driven member.

18. An electronic apparatus, comprising:
a to-be-driven member including a to-be-driven gear; and
the gear transmitting device of claim 2 for driving the to-be-driven member.

19. An electronic apparatus, comprising:
a to-be-driven member including a to-be-driven gear; and
the gear transmitting device of claim 3 for driving the to-be-driven member.

20. An electronic apparatus, comprising:
a to-be-driven member including a to-be-driven gear; and
the gear transmitting device of claim 4 for driving the to-be-driven member.
